(19) United States
(12) Patent Application Publication
(10) Pub. No.: US 2024/0225369 A1
(43) Pub. Date: Jul. 11, 2024

(54) INGREDIENT SUPPLYING DEVICE, AND INGREDIENT STORAGE EQUIPMENT INCLUDING THE SAME

(71) Applicant: TECHMAGIC INC., Tokyo (JP)

(72) Inventors: Kohei YOKOUCHI, Tokyo (JP); Naoto WATANABE, Tokyo (JP); Ryosuke TAJIMA, Tokyo (JP)

(21) Appl. No.: 18/616,178

(22) Filed: Mar. 26, 2024

Related U.S. Application Data
(63) Continuation of application No. PCT/JP2022/021207, filed on May 24, 2022.

(30) Foreign Application Priority Data
Sep. 27, 2021 (JP) 2021-157284

(51) Int. Cl. A47J 44/00

(52) U.S. Cl. CPC A47J 44/00

(57) ABSTRACT

Provided are an ingredient supplying device that reliably and simply separates ingredients only from an ingredient container and automatically supplies the ingredients to a cooking container, and ingredient storage equipment that includes this device. An ingredient container transporting mechanism has an ingredient container inverting unit provided at a container carrying-out end of the container transporting mechanism to vertically invert an upper opening of an ingredient container downward, and an ingredient separating mechanism has an ingredient supplying sleeve has an ingredient extracting hole that is narrower than an upper opening of the ingredient container and is opened at an end of the sleeve.

### FIELD

The present invention relates to an ingredient supplying device and ingredient storage equipment including this device.

### BACKGROUND

In recent years, with the development of a rich food culture, there has been a demand for the preparation of a wide variety of dishes using a wide variety of ingredients. In the food and beverage industry, due to various factors such as securing cooks, maintaining cooking skills, and improving the cooking environment, there has been a rapid demand for automation of food preparation and an increasing demand for automatic cooking equipment that automates food preparation.

A food ingredient supplying device (for example, Patent Literature 1) that is known as one element of such automatic cooking equipment and for supplying food ingredients (ingredients) includes the following: a food ingredient container stock rack that contains food ingredient containers, a food ingredient container dropping device that drops a predetermined food ingredient container from the food ingredient container stock rack, a food ingredient container sliding device that slides and transports the food ingredient container dropped from the food ingredient container dropping device, a food ingredient container taking out device that rotates the food ingredient container transported by the food container sliding device and takes out ingredients contained in the food ingredient container, and a food ingredient container stocking device that stocks the food ingredient container taken out by the food ingredient container taking out device.

### CITATION LIST

### Patent Literature

Patent Literature 1: WO 2020/166723 A (in particular, FIGS. 9 to 18)

### SUMMARY

### Technical Problem

In the food ingredient supplying device described above, when the transported food ingredient container is rotated to take out the ingredients contained in the food ingredient container, if the food ingredient container contains frozen ingredients or relatively viscous ingredients such as pastes made of mashed meat or vegetables, the ingredients cannot be successfully separated from the food ingredient container.

Therefore, the present invention solves the aforementioned problem of the conventional technology, that is, one of the purposes of the present invention is to provide an ingredient supplying device that reliably and simply separates the ingredients only from the ingredient container and automatically supplies the ingredients to a cooking container, and to provide ingredient storage equipment that includes this device.

### Solution to Problem

The invention according to claim 1 is an ingredient supplying device comprising an ingredient container rack for separately taking out and freely holding one or more ingredient containers that contain ingredients, an ingredient container transporting mechanism for horizontally moving and carrying out the ingredient containers, which have been separately taken out from a lower part of the ingredient container rack and vertically inverted, and an ingredient separating mechanism for taking out ingredients only from the ingredient containers, which have been carried out and dropped from the ingredient container transporting mechanism, and separately collecting the ingredient containers from which the ingredients have been taken out, wherein the ingredient container transporting mechanism has an ingredient container inverting unit that vertically inverts an upper opening of the ingredient containers downward, and the ingredient separating mechanism has an ingredient supplying sleeve that has an ingredient extracting hole that is narrower than the upper opening of the ingredient containers and is opened at an end of the sleeve, thereby solving the aforementioned problem.

In addition to the configuration of the ingredient supplying device according to claim 1, the ingredients taking out from the ingredient containers have been carried out and have been supplied from the ingredient containers into a cooking container that is waiting in a drop area.

In addition to the configuration of the ingredient supplying device according to claim 1, the ingredient separating mechanism has an ingredient supplying sleeve that is perpendicularly installed in the outer area of the ingredient container rack and has an ingredient extracting hole that is narrower than the upper opening of the ingredient containers and is opened at an end of the sleeve, and a container collecting chute that is connected to the end of the sleeve of the ingredient supplying sleeve and individually collects the ingredient containers.

In addition to the configuration of the ingredient supplying device according to claim 1, the ingredient container inverting unit of the ingredient container transporting mechanism includes an ingredient container carrying-out member that includes a container contact surface curved toward the ingredient container and moves the ingredient container horizontally in contact with the container contact surface to push out the ingredient container from the container carrying-out end, and a pin provided at the container carrying-out end that serves as a fulcrum for inverted rotation by engaging an inverting rotation groove provided in a lower portion of the ingredient container, thereby further solving the aforementioned problem.

In addition to the configuration of the ingredient supplying device according to claim 1, in the invention according to claim 3, the ingredient supplying sleeve of the ingredient separating mechanism has a drop guide that causes the ingredient container to drop in a vertically inverted state, thereby solving the aforementioned problem.

In addition to the configuration of the ingredient supplying device according to claim 1, in the invention according to claim 4, the container collecting chute of the ingredient separating mechanism is arranged inclined toward an ingredient container collecting box below the container collecting chute, thereby further solving the aforementioned problem.

The invention according to claim 7 is ingredient storage equipment including the ingredient supplying device according to claim 1 and a heat-retention cabinet that incorporates and keeps warm the ingredient supplying device, wherein the heat-retention cabinet has a sleeve through-opening in a lower part of the ingredient supplying device through which the ingredient supplying sleeve of the ingredient separating mechanism can pass, thereby further solving the aforementioned problem.

### Advantageous Effects of Invention

The ingredient supplying device of the present invention includes an ingredient container rack that individually takes out and freely holds a large number of ingredient containers that contain ingredients, an ingredient container transporting mechanism that horizontally moves the ingredient containers individually taken out from a lower part of the ingredient container rack and carries out the ingredient containers in a vertically inverted state in an outer area adjacent to the ingredient container rack, and an ingredient separating mechanism that takes out ingredients only from the ingredient containers carried out and dropped from the ingredient container transporting mechanism, supplies the ingredients into a cooking container waiting in a drop area, and separately collects the ingredient containers from which the ingredients have been taken out, which not only enables individual and simple taking-out of the ingredients only from a large number of ingredient containers and separate collection of empty ingredient containers from which the ingredients have been taken out, but also has the following unique effects.

That is, with the ingredient supplying device of the invention according to claim 1, the ingredient container transporting mechanism has an ingredient container inverting unit that vertically inverts an upper opening of the ingredient containers downward, and the ingredient separating mechanism has an ingredient supplying sleeve that has an ingredient extracting hole that is narrower than an upper opening of the ingredient containers and is opened at an end of the sleeve, whereby when an ingredient container drops under its own weight from the ingredient supplying sleeve and collides with the container collecting chute, an impact force acts on the ingredient container, and the impact force causes the ingredient container and the ingredients to be separated, so that even frozen or relatively viscous ingredients only can be reliably and simply taken out via the ingredient extracting hole.

In addition to the effects of the ingredient supplying device of the invention according to claim 2, with the ingredient supplying device of the invention according to claim 1, even frozen or relatively viscous ingredients only can be reliably and simply taken out via the ingredient extracting hole and automatically supplied into the cooking container that is waiting in the drop area.

In addition to the effects of the ingredient supplying device of the invention according to claim 3, with the ingredient supplying device of the invention according to claim 1, the ingredient separating mechanism has an ingredient supplying sleeve that is perpendicularly installed in the outer area of the ingredient container rack and has an ingredient extracting hole that is narrower than the upper opening of the ingredient containers and is opened at an end of the sleeve, and a container collecting chute that is connected to the end of the sleeve of the ingredient supplying sleeve and individually collects the ingredient containers, whereby when an ingredient container drops under its own weight from the ingredient supplying sleeve and collides with the container collecting chute, an impact force acts on the ingredient container, and the impact force causes the ingredient container and the ingredients to be separated, so that even frozen or relatively viscous ingredients only can be reliably and simply taken out via the ingredient extracting hole, and the ingredient containers are individually collected by the container collecting chute.

In addition to the effects of the ingredient supplying device of the invention according to claim 4, with the ingredient supplying device of the invention according to claim 1, the ingredient container inverting unit of the ingredient container transporting mechanism includes an ingredient container carrying-out member that includes a container contact surface curved toward the ingredient container and moves the ingredient container horizontally in contact with the container contact surface to push out the ingredient container from the container carrying-out end, and a pin provided at the container carrying-out end that serves as a fulcrum for inverted rotation by engaging an inverting rotation groove provided in a lower portion of the ingredient container. As a result, the ingredient container contacts the container contact surface of the ingredient carrying-out member and is pushed in while being lifted along the container contact surface, and since the ingredient container rotates around the pin, which is engaged with the inverting rotation groove and serves as a fulcrum for inverted rotation, with a simple device configuration, the ingredient container can be inverted rotationally and converted to a posture in which the upper opening of the ingredient container faces downward.

With the ingredient supplying device of the invention according to claim 5, in addition to the effects of the ingredient supplying device of the invention according to claim 1, the ingredient separating mechanism has a drop guide that causes the ingredient container to drop in a vertically inverted state, so that the ingredient container drops in a vertically inverted state with the upper opening facing downward, thereby preventing the ingredients from separating from the ingredient container and scattering during the dropping of the ingredient container.

With the ingredient supplying device of the invention according to claim 6, in addition to the effects of the ingredient supplying device of the invention according to claim 1, the container collecting chute of the ingredient separating mechanism is arranged inclined toward an ingredient container collecting box below the container collecting chute, so that after the ingredients are separated from the ingredient container, the empty ingredient container slides downward by its own weight along the inclined container collection chute via an ingredient separating hole area and is collected in the ingredient container collecting box, thereby eliminating the need for manpower to remove the empty ingredient container from the container collection chute of the ingredient supplying sleeve.

With ingredient storage equipment of the invention according to claim 7, in addition to the effects of the ingredient supplying device of the invention according to claim 1, the ingredient storage equipment includes the ingredient supplying device according to claim 1 and a heat-retention cabinet that incorporates and keeps warm the ingredient supplying device, wherein the heat-retention cabinet has a sleeve through-opening in a lower part of the ingredient supplying device through which the ingredient supplying sleeve of the ingredient separating mechanism can pass, so that the ingredients can be stored according to each temperature condition, such as refrigerated, frozen, room temperature, and warm, and the ingredients can be kept in a suitable condition until just before being fed into the cooking container.

### BRIEF DESCRIPTION OF DRAWINGS

FIG. 1 is a front schematic view that schematically illustrates automatic cooking equipment. The automatic cooking equipment contains ingredient storage equipment including an ingredient supplying device that is an embodiment of the present invention and a heat-retention cabinet that incorporates the ingredient supplying device.

FIG. 2 is a schematic perspective view of the ingredient supplying device illustrated in FIG. 1.

FIG. 3 is a configuration diagram of the ingredient supplying device illustrated in FIG. 1.

FIG. 4 is a perspective view in IV-IV section of the ingredient supplying device illustrated in FIG. 1.

FIG. 5A is a front view of an ingredient container used in the ingredient supplying device that is an embodiment of the present invention.

FIG. 5B is a side view of the ingredient container used in the ingredient supplying device that is an embodiment of the present invention.

FIG. 6A is a VI A-VI A sectional view of an ingredient container transporting mechanism that constitutes the ingredient supplying device illustrated in FIG. 4.

FIG. 6B is a bottom view of the ingredient container transporting mechanism that constitutes the ingredient supplying device illustrated in FIG. 4.

FIG. 6C is a VI C-VI C partial sectional view of an ingredient separating mechanism that constitutes the ingredient supplying device illustrated in FIG. 4.

FIG. 7A is a sectional view illustrating a state in which the ingredient container transporting mechanism is transporting the ingredient container in the ingredient supplying device that is an embodiment of the present invention.

FIG. 7B is a sectional view illustrating a state in which the ingredient container transporting mechanism rotates the ingredient container in the ingredient supplying device that is an embodiment of the present invention.

FIG. 7C is an enlarged sectional view for explaining a rotational operation of the ingredient container by means of an ingredient container inverting unit that constitutes the ingredient container transporting mechanism illustrated in FIG. 7B.

FIG. 7D is an enlarged sectional view for explaining the rotational operation of the ingredient container by the ingredient container inverting unit following FIG. 7C.

FIG. 7E is an enlarged sectional view for explaining the rotational operation of the ingredient container by the ingredient container inverting unit following FIG. 7D.

FIG. 7F is a sectional view illustrating a state of the ingredient container dropping through the ingredient separating mechanism in the ingredient supplying device that is an embodiment of the present invention.

FIG. 7G is a sectional view illustrating a state in which ingredients are separated and taken out via an ingredient extracting hole from the ingredient container that has dropped through the ingredient separating mechanism in the ingredient supplying device that is an embodiment of the present invention.

### DESCRIPTION OF EMBODIMENTS

A specific embodiment of the present invention can be any as long as the present invention has an ingredient supplying device including an ingredient container rack that individually takes out and freely holds a large number of ingredient containers that contain ingredients, an ingredient container transporting mechanism that horizontally moves the ingredient containers individually taken out from a lower part of the ingredient container rack and carries out the ingredient containers in a vertically inverted state in an outer area adjacent to the ingredient container rack, and an ingredient separating mechanism that takes out ingredients only from the ingredient containers carried out and dropped from the ingredient container transporting mechanism, supplies the ingredients into a cooking container waiting in a drop area, and separately collects the ingredient containers from which the ingredients have been taken out, wherein the ingredient transporting mechanism has an ingredient container inverting unit that is provided at a container carrying-out end of the ingredient container transporting mechanism and vertically inverts an upper opening of the ingredient containers downward, and an ingredient separating mechanism has an ingredient supplying sleeve that is perpendicularly installed in the outer area of the ingredient container rack and has an ingredient extracting hole that is opened at an end of the sleeve and is narrower than the upper opening of the ingredient container, and a container collecting chute that is connected to the end of the sleeve of the ingredient supplying sleeve and separately collects the ingredient containers.

For example, the ingredient supplying device of the present invention is mainly installed in restaurants, but the location of the ingredient supplying device of the present invention is not limited to restaurants and the ingredient supplying device may be installed in food courts, business offices, homes, and the like.

For example, the ingredients stored in the ingredient supplying device of the present invention may be any foodstuff, such as rice, noodles, vegetables, fish, grains, and various seasonings.

### Embodiment 1

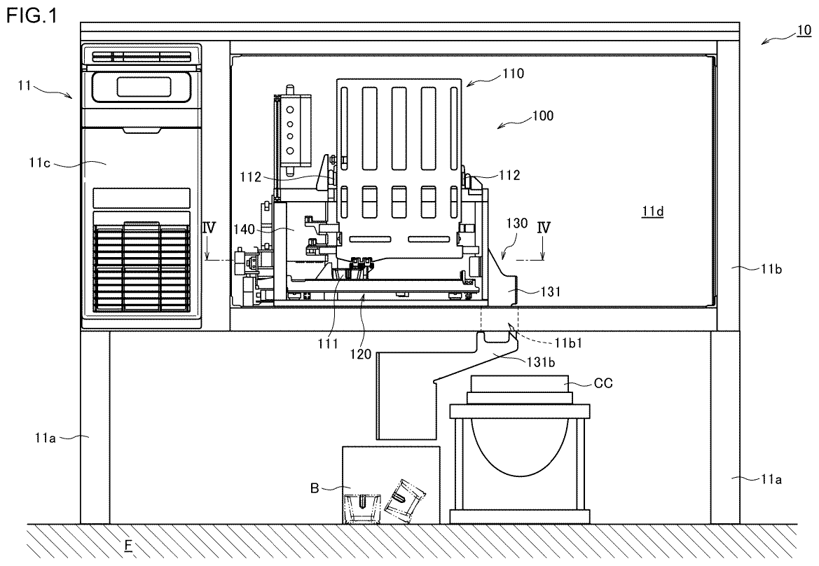

The following is a description of automatic cooking equipment 10 that is an embodiment of the present invention, based on FIGS. 1 to 7G.

### <1. Outline of Automatic Cooking Equipment>

An overview of the automatic cooking equipment 10 is described based on FIG. 1.

Here, FIG. 1 is a front schematic view that schematically illustrates automatic cooking equipment. The automatic cooking equipment contains ingredient storage equipment including the ingredient supplying device that is an embodiment of the present invention and a heat-retention cabinet that incorporates the ingredient supplying device.

First, as illustrated in FIG. 1, the automatic cooking equipment 10 includes ingredient storage equipment 11 installed on a cooking table F and cooking containers CC such as pots and pans placed on the cooking table F.

The ingredient storage equipment 11 includes a storage shelf 11b supported at a level higher than the cooking table F by a support column 11a, and a temperature control device 11c attached and provided on the storage shelf 11b.

For the sake of explanation, the storage shelf 11b is illustrated as if it is open from the front to the back, but in reality, the storage shelf 11b is configured as a heat-insulated heat-retention cabinet 11d with heat-insulated walls on the sides and back, which are not illustrated, and a freely openable insulated door on the front, which is not illustrated.

The temperature control device 11c includes a cooling or warming device, or the like, and can set temperature conditions suitable for storing ingredients, such as refrigerated, frozen, room temperature, and warm, for an internal space of the heat-retention cabinet 11d.

The interior space of the heat-retention cabinet 11d that is included in the ingredient storage equipment 11 incorporates and keeps warm an ingredient supplying device 100.

An ingredient separating mechanism 130, which constitutes the ingredient supplying device 100, is provided with an ingredient supplying sleeve 131 that passes through a sleeve through-opening 11b1 provided in the bottom of the heat-retention cabinet 11d.

The cooking container CC is placed directly under the ingredient supplying sleeve 131, which passes through the sleeve through-opening 11b1 of the heat-retention cabinet 11d, and accepts an ingredient I separated from an ingredient container 111 that drops through the ingredient supply sleeve 131.

A container collecting chute 131b of the ingredient supplying sleeve 131 is arranged inclined toward an ingredient container collecting box B below the ingredient supply sleeve 131.

Although the ingredient container collecting box B is placed on top of the cooking table F in FIG. 1, it may be configured to be placed below the cooking table F together with a hole that is formed below the ingredient supplying sleeve 131 and passes through the cooking table F.

### <2. Outline of Ingredient Supplying Device>

Next, an overview of the ingredient supplying device 100 is described based on FIGS. 1, 2, 3, 4, 5A, 5B, and 6A to 6C.

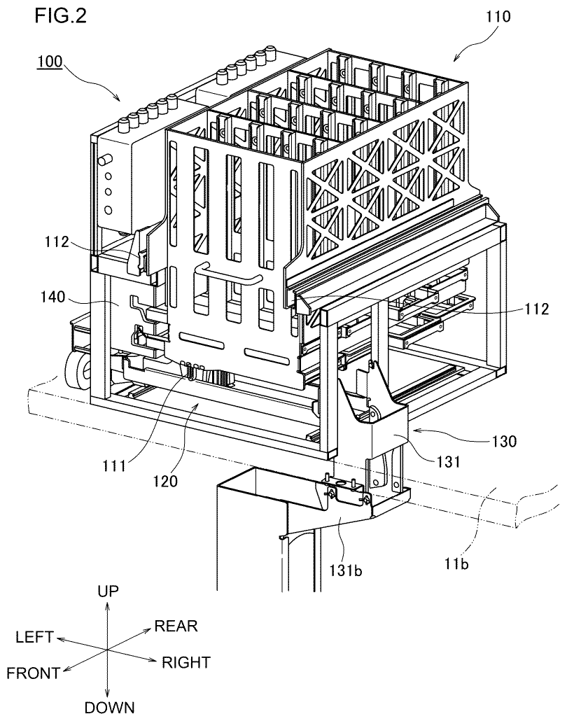

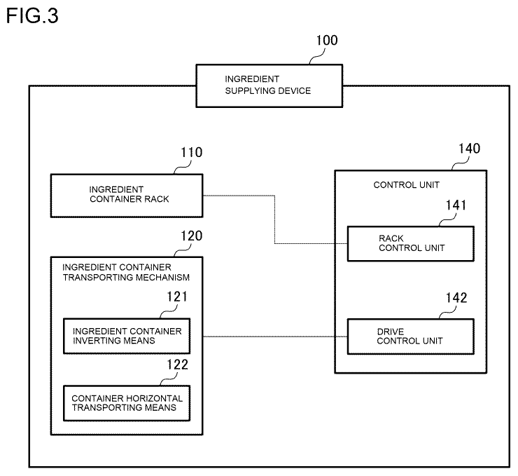

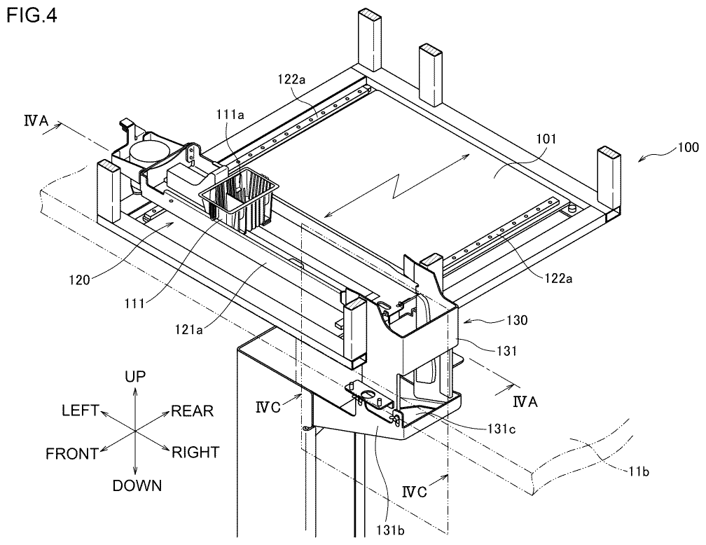

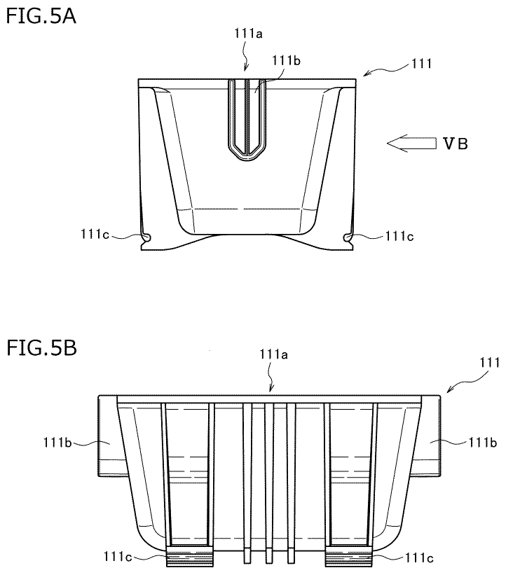

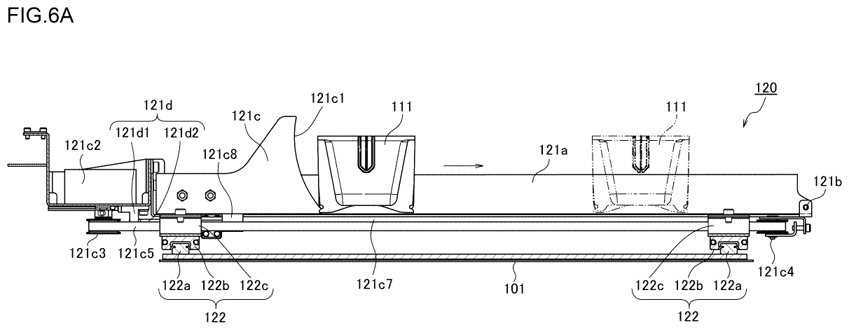

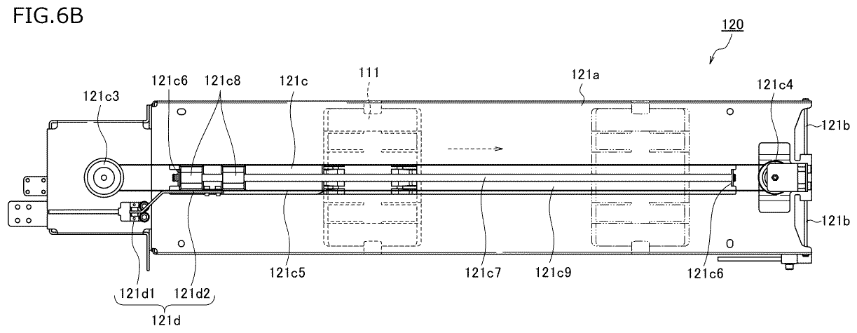

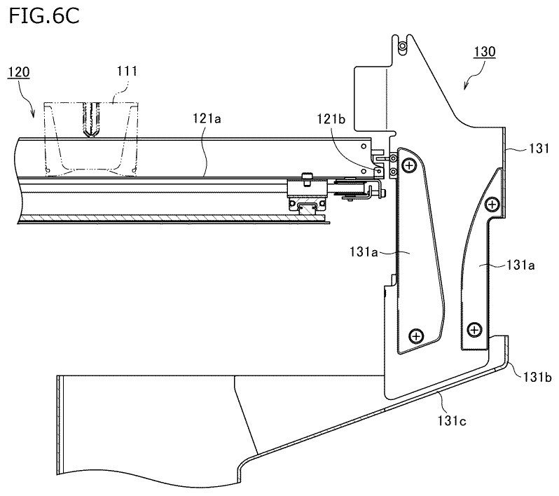

Here, FIG. 2 is a schematic perspective view of the ingredient supplying device illustrated in FIG. 1, FIG. 3 is a configuration diagram of the ingredient supplying device illustrated in FIG. 1, FIG. 4 is a perspective view in IV-IV section of the ingredient supplying device illustrated in FIG. 1, FIG. 5A is a front view of the ingredient container used in the ingredient supplying device that is an embodiment of the present invention, FIG. 5B is a side view of the ingredient container used in the ingredient supplying device that is an embodiment of the present invention, FIG. 6A is a VI A-VI A sectional view of the ingredient container transporting mechanism that constitutes the ingredient supplying device illustrated in FIG. 4, FIG. 6B is a bottom view of the ingredient container transporting mechanism that constitutes the ingredient supplying device illustrated in FIG. 2, and FIG. 6C is a VI C-VI C partial sectional view of the ingredient separating mechanism that constitutes the ingredient supplying device illustrated in FIG. 2.

As illustrated in FIGS. 1, 2, and 4, the ingredient supplying device 100 includes an ingredient container rack 110 that individually takes out and freely holds a large number of ingredient containers 111 containing the ingredient I that has been fed through from an upper opening 111a formed on a top surface of the ingredient container, an ingredient container transporting mechanism 120 that horizontally moves the ingredient containers 111 individually taken out from a lower part of the ingredient container rack 110 and carries out the individually taken out ingredient containers in a vertically inverted state in the outer area adjacent to the ingredient container rack 110, and the ingredient separating mechanism 130 that takes out the ingredient I only from the ingredient containers 111 carried out and dropped from the ingredient container transporting mechanism 120, supplies the ingredient I to the cooking container CC waiting in the drop area, and separately collects the ingredient containers 111 from which the ingredient I has been taken out.

Furthermore, as illustrated in FIGS. 1, 2, and 3, the ingredient supplying device 100 includes a control unit 140.

The control unit 140 has a rack controller 141 that controls the ingredient container rack 110 to select individual ingredient containers 111 from the ingredient container rack 110 and take out the individual containers 111 toward the ingredient container transporting mechanism 120, and a drive controller 142 that drives and controls the ingredient container transporting mechanism 120 to transport the ingredient containers 111 taken out toward the ingredient transporting mechanism 120 to the ingredient separating mechanism 130.

### <2.1 Specific Configuration of Ingredient Container Rack>

As illustrated in FIGS. 1, 2, and 4, the ingredient container rack 110 has a space inside to hold a large number of ingredient containers 111 arranged in a vertical height direction, a horizontal width direction, that is, a carrying-out direction, and a front and rear length direction, that is, a transporting direction, of the ingredient supplying device 100.

Henceforth, unless otherwise stated, “height direction”, “carrying-out direction”, and “transporting direction” refer to each direction of the ingredient supplying device 100.

The number of ingredient containers 111 stored by the ingredient container rack 110 is not limited, as long as the ingredient containers can be physically held. For example, the ingredient container rack 110 can store eight ingredient containers in the height direction, four ingredient containers in the carrying-out direction, and four ingredient containers in the transporting direction.

Each of the large number of ingredient containers 111 stored by the ingredient container rack 110 can contain different types of the ingredient I.

The ingredient container rack 110 individually selects ingredient containers 111 from the large number of ingredient containers 111 and drops the ingredient containers 111 one by one to supply the ingredient containers to the ingredient container transporting mechanism 120.

As illustrated in FIGS. 1 and 2, a pair of rail-like members 112 extending in a length direction are provided on both sides of the ingredient container rack 110.

By sliding the rail-like members 112 and pulling out the ingredient container rack 110 toward the front, the ingredient container rack 110 can be refilled with the ingredient containers 111.

### <2.1.1 Specific Configuration of Ingredient Container>

As illustrated in FIGS. 4, 5A, and 5B, the upper opening 111a is formed on the top surface of the ingredient container 111, which contains the ingredient I fed from the upper opening 111a.

Note that, in FIG. 4, indication of the ingredient I contained in the ingredient container 111 is omitted.

As illustrated in FIGS. 5A and 5B, the front and back of the ingredient container 111 are provided with a pair of protruding portions 111b that protrude forward and backward.

In addition, a pair of inverting rotation grooves 111c are provided in a lower portion of a side of the ingredient container 111, and engage a pair of pins 121b that constitute an ingredient container inverting unit 121 of the ingredient container transporting mechanism 120 described below.

The front of the ingredient container 111 illustrated in FIG. 5A and the back, which is not illustrated, are formed in the same shape.

One side of the ingredient container 111 illustrated in FIG. 5B and the other side, which is not illustrated, are formed in the same shape.

In other words, the ingredient container 111 is symmetrical in shape on opposite sides.

### <2.2 Specific Configuration of Ingredient Container Transporting Mechanism>

As illustrated in FIGS. 4, 6A, and 6B, the ingredient container transporting mechanism 120 has the ingredient container inverting unit 121 that rotates the ingredient container 111 until the upper opening 111a is facing downward, and a container horizontally transporting unit 122 that enables the ingredient container inverting unit 121 to move in the transporting direction of the ingredient supplying device 100.

For illustrative purposes, a base 101 and the container horizontally transporting unit 122 are omitted in FIG. 6B.

### <2.2.1 Specific Configuration of Ingredient Container Inverting Unit>

As illustrated in FIGS. 6A and 6B, the ingredient container inverting unit 121 includes a guide rail 121a, the pin 121b, and an ingredient container carrying-out member 121c.

The guide rail 121a guides the ingredient container 111 dropped and supplied from the ingredient container rack 110 in a horizontal direction.

The pair of pins 121b are provided at an end of the guide rail 121a perpendicular to each other in the horizontal direction in which the ingredient container 111 is guided, and engage the pair of inverting rotation grooves 111c provided in the lower portion of the ingredient container 111 to serve as fulcrums for inverted rotation.

The ingredient container carrying-out member 121c moves along the guide rail 121a and pushes in the ingredient container 111 horizontally, as illustrated by the rightward arrow in FIG. 6A.

As illustrated in FIG. 6A, the ingredient container carrying-out member 121c has an inverse arc-shaped curved portion standing in contact with the ingredient container 111, that is, a container contact surface 121cl that curves toward the ingredient container 111.

As illustrated in FIGS. 6A and 6B, a configuration for moving the ingredient container carrying-out member 121c along the guide rail 121a includes a motor 121c2 provided adjacent to a left end of the guide rail 121a, a first pulley 121c3 on a drive side provided coaxially with a rotating shaft of the motor 121c2, a second pulley 121c4 on a driven side provided at a right end of the guide rail 121a on the same horizontal plane as the first pulley 121c3, and a belt 121c5 hung between the first pulley 121c3 and the second pulley 121c4.

As described in detail below, the ingredient container carrying-out member 121c is moved horizontally on the guide rail 121a, that is, in the carrying-out direction, by a circumferential drive of the belt 121c5.

As illustrated in a bottom view of the guide rail 121a in FIG. 6B, a pair of support members 121c6 are provided in an area surrounded by the belt 121c5 hung between the first pulley 121c3 and the second pulley 121c4.

The pair of support members 121c6 are provided near the first and second pulleys 121c3 and 121c4, respectively, and support ends of a guide shaft 121c7, which extends parallel to the belt 121c5 hung between both pulleys.

The guide shaft 121c7 passes through a moving member 121c8, which is provided so as to be slidable on the guide shaft 121c7.

The guide rail 121a has a passing-through area 121c9 that passes vertically along the guide shaft 121c7.

The moving member 121c8 is connected to the ingredient container carrying-out member 121c through the passing-through area 121c9.

In FIG. 6B, two moving members 121c8 are provided at regular intervals in a direction of extension of the guide shaft 121c7, that is, in the carrying-out direction, but only one may be provided.

As illustrated in FIG. 6B, the moving member 121c8 is fixed to one end of one side of the belt 121c5 that moves parallel to the guide shaft 121c7.

The moving member 121c8, which is fixed to the belt 121c5, slides along the guide shaft 121c7 in conjunction with the movement of the belt 121c5, and the ingredient container carrying-out member 121c, which is connected to the moving member 121c8 through the passing-through area 121c9, moves along the guide rail 121a.

An optical sensor 121dl is provided near the first pulley 121c3, which is provided adjacent to the left end of the guide rail 121a.

The optical sensor 121dl is configured, for example, as a groove-type sensor having a pair of convex portions protruding downward at regular intervals in the transporting direction orthogonal to the carrying-out direction and a concave portion sandwiched between each convex portion.

One convex portion of the optical sensor 121d1 includes a light projector that projects light, and the other convex portion has a light receiver that is arranged opposite the light projector and receives the light projected from the light projector. When the light projected from the light projector toward the light receiver is blocked, the optical sensor 121dl detects the presence of an object in the concave portion.

Furthermore, a detectable member 121d2 is provided on one end of one side of the belt 121c5 to which the moving member 121c8 is fixed.

The detectable member 121d2 is fixed to one end of an outer side of the belt 121c5 to which the moving member 121c8 is fixed to one end of an inner side, and includes a portion extending from the end of the outer side in parallel with the belt 121c5 while contacting the belt 121c5, a portion extending from this portion to increase a distance from the belt 121c5 to approach the optical sensor 121d1, and a portion extending from this portion again in parallel with the belt 121c5 to be positionable in the above-mentioned concave portion of the optical sensor 121d1.

The optical sensor 121dl and the detectable member 121d2 constitute an ingredient container carrying-out member positioning unit 121d, and are provided so that when the ingredient container carrying-out member 121c is at the left end of the guide rail 121a illustrated in FIGS. 6A and 6B, that is, at a last end position, a part of the detectable member 121d2 is located in the above-mentioned concave portion in the optical sensor 121d1.

When the optical sensor 121dl detects that a part of the detectable member 121d2 is located in the above-mentioned concave portion, the optical sensor 121dl sends a detection signal to the aforementioned control unit 140.

The control unit 140 controls rotation of the motor 121c2 taking a position when the detection signal is received from the optical sensor 121dl as a reference position, that is, when the ingredient container carrying-out member 121c is at the last end position of the guide rail 121a.

In a state in which the belt 121c5, which is hung on the first pulley 121c3 that is coaxial with the rotating shaft of the motor 121c2, is hung on the second pulley 121c4, when the motor 121c2 is rotated, the moving member 121c8 fixed to the belt 121c5 slides along the guide shaft 121c7, and the ingredient container carrying-out member 121c, which is connected to the moving member 121c8 through the passing-through area 121c9, moves along the guide rail 121a.

The ingredient container carrying-out member 121c moves the ingredient container 111 horizontally along the guide rail 121a, and pushes in the ingredient container 111 horizontally until the inverting rotation groove 111c provided in the lower portion of the ingredient container 111 is engaged with the pin 121b provided at the end of the guide rail 121a.

In the present embodiment, the operation in which the ingredient container carrying-out member 121c moves along the guide rail 121a and pushes in the ingredient container 111 horizontally is realized by a belt drive, but the configuration is not limited to a belt drive as long as the configuration enables similar operation.

### <2.2.2 Specific Configuration of Container Horizontally Transporting Unit>

As illustrated in FIGS. 4 and 6A, the container horizontally transporting unit 122 includes a transferring rail 122a, a sliding member 122b, and a mounting member 122c.

As illustrated in FIG. 4, the transferring rails 122a extend in the transporting direction and are provided in a pair at both ends in the carrying-out direction on the base 101 that forms the bottom of the ingredient supplying device 100.

As illustrated in FIG. 6A, the sliding member 122b is configured to move along transferring rail 122a and enable positioning by means of a linear motor or the like.

The mounting member 122c is a member for attaching the sliding member 122b to the guide rail 121a of the ingredient container inverting unit 121.

The container horizontally transporting unit 122 has the above-mentioned configuration, whereby the sliding member 122b attached to the guide rail 121a of the ingredient container inverting unit 121 via the mounting member 122c moves along the transferring rail 122a in the transporting direction, so that the ingredient container inverting unit 121 (guide rail 121a) is moved in the transporting direction, as illustrated by the arrow in FIG. 4.

Movement of the ingredient container inverting unit 121 by the container horizontally transporting unit 122 is performed with the following procedure.

First, the container horizontally transporting unit 122 moves the ingredient container inverting unit 121 in the transporting direction so that the guide rail 121a of the ingredient container inverting unit 121 comes under a supplying position where the ingredient container 111 drops and is supplied from the ingredient container rack 110.

Next, the container horizontally transporting unit 122 moves the ingredient container inverting unit 121 further in the transporting direction to a predetermined carrying-out position where the ingredient separating mechanism 130 described below is provided.

These movement operations are controlled by the aforementioned control unit 140.

As illustrated in FIG. 4, the predetermined carrying-out position is the very front end in the transporting direction of the ingredient supplying device 100 in an embodiment of the present invention.

If the supplying position where the ingredient container 111 drops from the ingredient container rack 110 and is supplied to the guide rail 121a of the ingredient container inverting unit 121 is the predetermined carrying-out position, the ingredient container inverting unit 121 does not require further movement in the transporting direction.

### <2.3 Specific Configuration of Ingredient Separating Mechanism>

As illustrated in FIG. 4, the ingredient separating mechanism 130 is provided at a position connected to the end of the guide rail 121a when the ingredient container inverting unit 121 is positioned at the very front end of the transporting direction.

As illustrated in FIGS. 4 and 6C, the ingredient separating mechanism 130 has the ingredient supplying sleeve 131, which is perpendicularly installed in the outer area of the ingredient container rack 110 and receives from above the ingredient container 111 with the upper opening 111a vertically inverted downward.

The ingredient supplying sleeve 131 is provided with a drop guide 131a that allows the ingredient container 111 to drop in a vertically inverted state.

As illustrated in the sectional view in FIG. 6C, the drop guide 131a is provided as a pair of guides on a rear side of the inside of the ingredient supplying sleeve 131.

A similar drop guide 131a is also provided on the front side of the inside of the ingredient supplying sleeve 131, which is not illustrated, opposite and symmetrically facing the drop guide 131a provided on the rear side.

The distance between each of the guides of the left and right pair of guides that constitute the drop guide 131a gradually shrinks downward until it is slightly larger than the width of the protruding portion 111b (see FIG. 5A) of the ingredient container 111.

The ingredient container 111, which is rotated until the upper opening 111a is facing downward, drops down the ingredient supplying sleeve 131 in a vertically inverted state, with the protruding portion 111b guided by the drop guide 131a.

The ingredient supplying sleeve 131 has an ingredient extracting hole 131c opened at the end of the sleeve that is narrower than the upper opening 111a of the ingredient container 111, and the container collecting chute 131b that is connected to the end of the sleeve and separately collects the ingredient containers 111.

The container collecting chute 131b of the ingredient supplying sleeve 131 is arranged inclined toward the ingredient container collecting box B (see FIG. 1), which is placed below the ingredient supplying sleeve 131.

<3. Explanation of Series of Movements of Ingredient Container from Transportation to Separation of Ingredients>

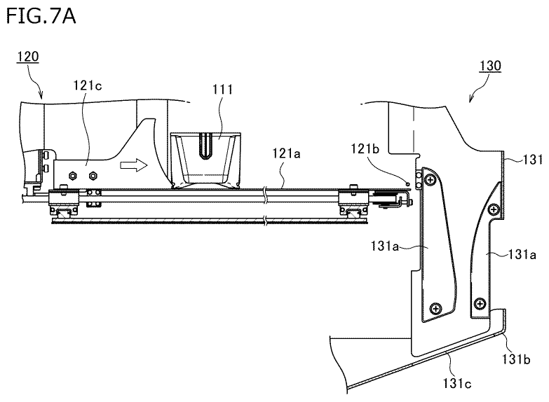

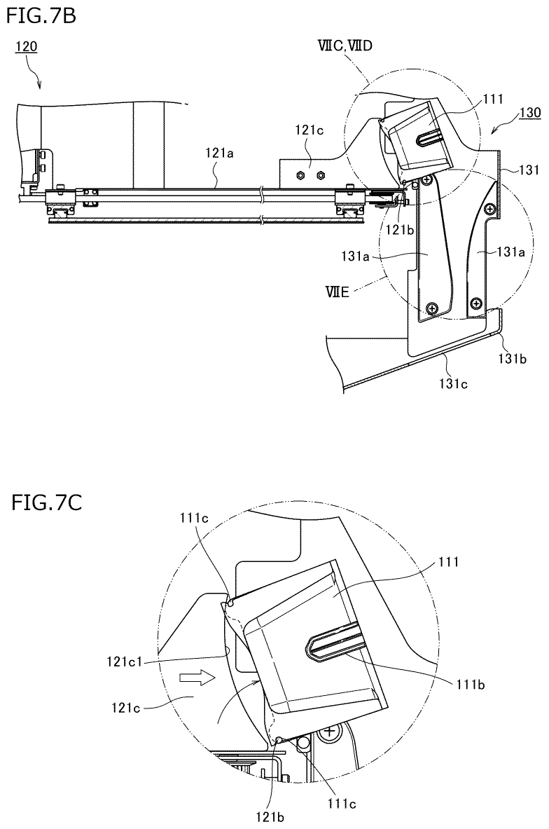

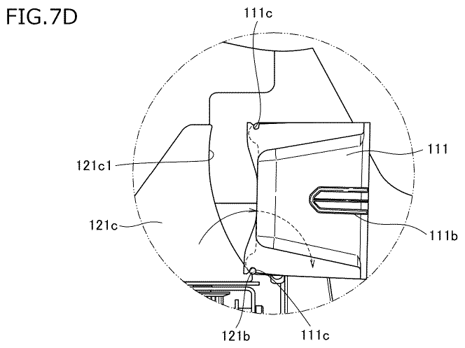

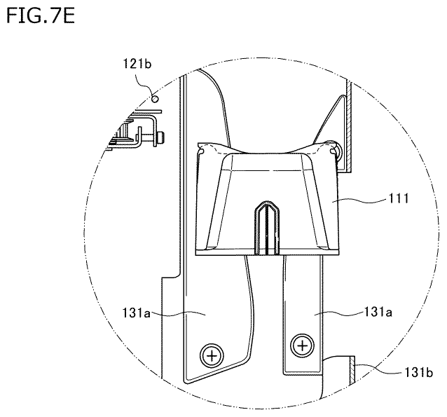

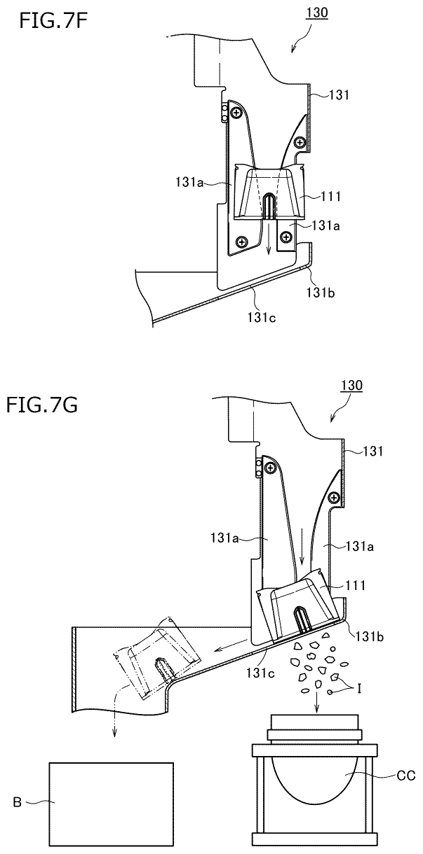

Based on FIGS. 7A to 7G, a series of movements of the ingredient container from transportation to the separation of ingredients is described.

Here, FIG. 7A is a sectional view illustrating the state in which the ingredient container transporting mechanism is transporting the ingredient container, FIG. 7B is a sectional view illustrating the state in which the ingredient container transporting mechanism is rotating the ingredient container, FIG. 7C is an enlarged sectional view to explain the rotating operation of the ingredient container by the ingredient container inverting unit that constitutes the ingredient container transporting mechanism illustrated in FIG. 7B, FIG. 7D is an enlarged sectional view to explain the rotating operation of the ingredient container by the ingredient container inverting unit following FIG. 7C, FIG. 7E is an enlarged sectional view to explain the rotating operation of the ingredient container by the ingredient container inverting unit following FIG. 7D, and FIG. 7F is a sectional view illustrating the state in which the ingredient container is dropping through the ingredient separating mechanism. FIG. 7G is a sectional view illustrating the state in which the ingredients are separated and taken out via the ingredient extracting hole from the ingredient container that has dropped through the ingredient separating mechanism.

First, as illustrated in FIG. 7A, the ingredient container carrying-out member 121c is at the left end of the guide rail 121a, that is, the last end position.

In this state, the ingredient container 111 is dropped from the ingredient container rack 110 and supplied onto the guide rail 121a.

In FIGS. 7A and 7B, the guide rail 121a is illustrated with its length in a width direction omitted.

In FIG. 7A, the ingredient container carrying-out member 121c is in contact with the lower portion of the ingredient container 111.

However, depending on the position at which the ingredient container 111 is dropped from the ingredient container rack 110 and supplied onto the guide rail 121a, the ingredient container carrying-out member 121c is not necessarily in contact with the ingredient container 111 yet.

Even in such a case, as illustrated by the rightward arrow in FIG. 7A, the ingredient container carrying-out member 121c moves horizontally along the guide rail 121a toward the right end of the guide rail 121a where the ingredient separating mechanism 130 is provided, that is, a leading end position that is the container carrying-out end, and contacts the lower portion of the ingredient container 111.

Next, as illustrated in FIG. 7B, the ingredient container carrying-out member 121c moves from the state of being in contact with the lower portion of the ingredient container 111 illustrated in FIG. 7A, pushes in the ingredient container 111 horizontally, and moves the ingredient container 111 horizontally until the inverting rotation groove 111c provided on the lower portion of the ingredient container 111 on an opposite side from the side in contact with the ingredient container carrying-out member 121c engages the pin 121b provided on the end of the guide rail 121a.

As illustrated in FIG. 7C, the ingredient container carrying-out member 121c has the container contact surface 121c1 that curves toward the ingredient container 111.

The ingredient container carrying-out member 121c engages the inverting rotation groove 111c of the ingredient container 111 and the pin 121b of the ingredient container inverting unit 121, then pushes in the ingredient container 111 further, as illustrated by the rightward arrow in FIG. 7C.

Then the lower portion of the side of the ingredient container 111 opposite the side provided with the inverting rotation groove 111c, which is engaged with the pin 121b, contacts the curved container contact surface 121cl of the container carrying-out member 121c, and the ingredient container 111 is pushed in while being lifted along the curved container contact surface 121cl and begins to rotate around the pin 121b, which is engaged with the inverting rotation groove 111c, as illustrated by the arc arrow in FIG. 7C.

Then, as illustrated by the arc arrow in FIG. 7D, when the ingredient container 111 is rotated until its center of gravity exceeds a vertical line from the pin 121b, it is further rotated by its own weight, even if it is no longer in contact with the curved container contact surface 121c1 of the ingredient container carrying-out member 121c.

Furthermore, as illustrated in FIG. 7E, the ingredient container 111 is rotated until the ingredient container 111 is vertically inverted with the upper opening 111a facing downward.

As illustrated by the downward arrow in FIG. 7F, the ingredient container 111 is vertically inverted with the top opening 111a facing downward and dropped through the ingredient supplying sleeve 131 of the ingredient separating mechanism 130.

While the ingredient container 111 drops through the ingredient supplying sleeve 131, the protruding portion 111b is guided by the drop guide 131a of the ingredient separating mechanism 130 to keep the ingredient container 111 in the vertically inverted state.

Finally, as illustrated in FIG. 7G, the ingredient container 111 collides with the container collecting chute 131b connected to the end of the sleeve of the ingredient supplying sleeve 131 while vertically inverted with the upper opening 111a facing downward.

When the ingredient container 111 drops under its own weight through the ingredient supplying sleeve 131 and collides with the container collecting chute 131b, an impact force acts on the ingredient container 111. The impact force separates the ingredient I from the ingredient container 111, and the ingredient I that was contained in the ingredient container 111 is separated from the ingredient container 111 and drops through the ingredient extracting hole 131c opened at the end of the sleeve of the ingredient supplying sleeve 131.

The cooking container CC is placed directly under the ingredient supplying sleeve 131, and accepts the ingredient I dropped via the ingredient extracting hole 131c.

Since the ingredient extracting hole 131c is narrower than the upper opening 111a of the ingredient container 111, the ingredient container 111 stays in the container collecting chute 131b, while only the ingredient I drops via the ingredient extracting hole 131c and is automatically supplied toward the cooking container CC waiting in the drop area of the ingredient I.

The container collecting chute 131b of the ingredient supplying sleeve 131 is arranged inclined toward the ingredient container collecting box B below the container collecting chute 131b, so that after the ingredient I is taken out via the ingredient extracting hole 131c, the empty ingredient container 111 then slides downward under its own weight along the container collecting chute 131b and is collected in the ingredient container collecting box B.

### <4. Effects of Ingredient Storage Equipment 11 and Ingredient Supplying Device 100>

With the ingredient storage equipment 11 described above, the ingredient storage equipment 11 includes an ingredient supplying device 100 and a heat-retention cabinet 11d that incorporates and keeps warm the ingredient supplying device 100. The heat-retention cabinet 11d has the sleeve through-opening 11b1 through which the ingredient supplying sleeve 131 passes below the ingredient supplying device 100, whereby the ingredient I is stored according to each temperature condition, such as refrigerated, frozen, room temperature, and warm, so that the ingredient I can be kept in a suitable condition until just before the ingredient I is fed into the cooking container CC.

With the ingredient supplying device 100 described above, the ingredient container transporting mechanism 120, which carries out the ingredient containers 111 individually taken out from the lower part of the ingredient container rack 110 in a state in which the ingredient containers are horizontally moved and vertically inverted in the outer area adjacent to the ingredient container rack 110, has an ingredient container inverting unit 121 provided at the carrying-out end of the ingredient container transporting mechanism 120 that vertically inverts the upper opening 111a of the ingredient containers 111 downward. The ingredient separating mechanism 130 has an ingredient supplying sleeve 131, which is perpendicularly installed in the outer area of the ingredient container rack 110 and has an ingredient extracting hole 131c that is narrower than the upper opening 111a of the ingredient container 111 and opened at the end of the sleeve, and a container collecting chute 131b, which is connected to the end of the sleeve of the ingredient supplying sleeve 131 and separately collects the ingredient containers 111, so that when the ingredient containers 111 dropping under their own weight from the ingredient supplying sleeve 131 collide with the container collecting chute 131b, an impact force acts on the ingredient containers 111. The impact force separates the ingredient I from the ingredient container 111, so that even a frozen or relatively viscous ingredient I only can be reliably and simply taken out via the ingredient extracting hole 131c and automatically supplied to the cooking container waiting in the drop area of the ingredient.

In addition, the ingredient container inverting unit 121 of the ingredient container transporting mechanism 120 includes the ingredient container carrying-out member 121c, which includes the container contact surface 121c1 that is curved toward the ingredient container 111, moves the ingredient container 111 horizontally in contact with the container contact surface, and pushes out the ingredient container 111 from the container carrying-out end, and the pin 121b, which is provided at the container carrying-out end and engages with the inverting rotation groove 111c provided in a lower portion of the ingredient container 111 to serve as a fulcrum for inverted rotation, whereby the ingredient container 111 contacts the container contact surface 121cl of the ingredient container carrying-out member 121c. Since the ingredient container 111 is rotated around the pin 121b, which serves as a fulcrum for inverted rotation by being engaged with the inverting rotation groove 111c, the ingredient container 111 is pushed in while being lifted along the container contact surface 121cl, and with a simple device configuration, the ingredient container 111 can be inversely rotated and converted to a posture in which the upper opening 111a of the ingredient container 111 faces downward.

In addition, the ingredient supplying sleeve 131 of the ingredient separating mechanism 130 has a drop guide 131a that causes the ingredient container 111 to fall in a vertically inverted state, so that the ingredient container 111 falls in the vertically inverted state with the upper opening 111a facing downward, thereby preventing the ingredient I from being separated from the ingredient container 111 and scattered during the dropping of the ingredient container 111.

In addition, the container collecting chute 131b of the ingredient separating mechanism 130 is arranged inclined toward the ingredient container collecting box B below the container collecting chute 131b, so that the empty ingredient container 111 slides down the inclined container collecting chute 131b under its own weight after the ingredient I is separated via the ingredient extracting hole 131c. Since the ingredient container 111 is collected in the ingredient container collecting box B, manpower to remove the empty ingredient container 111 from the container collecting chute 131b of the ingredient supplying sleeve 131 can be eliminated.

### Modified Embodiments

The above is a description of the ingredient storage equipment and ingredient supplying device, which are an embodiment of the present invention. However, the ingredient storage equipment and ingredient supplying device of the present invention are not limited to the ingredient storage equipment and ingredient supplying device of the above embodiment.

For example, in the embodiment described above, the ingredient container collecting box is placed on top of the cooking table, but the ingredient container collecting box may be configured to be placed below the cooking table along with a hole that is formed further below the ingredient supplying sleeve and passes through the cooking table.

For example, in the embodiment described above, the belt drive is used to realize the operation in which the ingredient container carrying-out member moves along the guide rail and pushes in the ingredient container horizontally, but a configuration other than the belt drive may be used if the configuration enables similar operation.

For example, in the embodiment described above, two moving members of the ingredient container carrying-out member are provided at regular intervals in the direction of extension of the guide shaft, but only one may be provided.

For example, in the embodiment described above, the moving member and guide shaft of the ingredient container carrying-out member may each be configured with a linear guide including a block and a linear rail.

For example, in the embodiment described above, the ingredient separating mechanism is provided at the very front end in the transporting direction of the ingredient supplying device, but the ingredient separating mechanism may be at a position other than the very front end if the ingredient separating mechanism is capable of separating ingredients from the ingredient container and supplying the ingredients to the cooking container.

In the embodiment described above, only one ingredient separating mechanism is provided, but it is possible to provide multiple ingredient separating mechanisms and configure the ingredient separating mechanisms to supply ingredients to different cooking containers through each ingredient separating mechanism.

### REFERENCE SIGNS LIST

10 Automatic cooking equipment
11 Ingredient storage equipment
11a Support column
11b Storage shelf
11b1 Sleeve through-opening
11c Temperature control device
11d Heat-retention cabinet
100 Ingredient supplying device
101 Base
110 Ingredient container rack
111 Ingredient container
111a Upper opening
111b Protruding portion
111c Inverting rotation groove
112 Rail-like member
120 Ingredient container transporting mechanism
121 Ingredient container inverting unit
121a Guide rail
121b Pin
121c Ingredient container carrying-out member
121c1 Curved container contact surface
121c2 Motor
121c3 First pulley
121c4 Second pulley
121c5 Belt
121c6 Supporting member
121c7 Guide shaft
121c8 Moving member
121c9 Passing-through area
121d Ingredient container carrying-out member
positioning unit
121d1 Optical sensor
121d2 Detectable member
122 Container horizontally transporting unit
122a Transferring rail
122b Sliding member
122c Mounting member
130 Ingredient separating mechanism
131 Ingredient supplying sleeve
131a Drop guide
131b Container collecting chute
131c Ingredient extracting hole
140 Control unit
141 Rack controller
142 Drive controller
F Cooking table
CC Cooking container
B Ingredient container collecting box
I Ingredient

1. An ingredient supplying device comprising an ingredient container rack for separately taking out and freely holding one or more ingredient containers that contain ingredients, an ingredient container transporting mechanism for horizontally moving and carrying out the ingredient containers, which have been separately taken out from a lower part of the ingredient container rack and vertically inverted, and an ingredient separating mechanism for taking out ingredients only from the ingredient containers, which have been carried out and dropped from the ingredient container transporting mechanism, and separately collecting the ingredient containers from which the ingredients have been taken out, wherein
the ingredient container transporting mechanism has an ingredient container inverting unit that vertically inverts an upper opening of the ingredient containers downward, and
the ingredient separating mechanism has an ingredient supplying sleeve that has an ingredient extracting hole that is narrower than the upper opening of the ingredient containers and is opened at an end of the sleeve.

2. The ingredient supplying device according to claim 1, wherein the ingredients taking out from the ingredient containers have been carried out and have been supplied from the ingredient containers into a cooking container that is waiting in a drop area.

3. The ingredient supplying device according to claim 1, wherein the ingredient separating mechanism has an ingredient supplying sleeve that is perpendicularly installed in the outer area of the ingredient container rack and has an ingredient extracting hole that is narrower than the upper opening of the ingredient containers and is opened at an end of the sleeve, and a container collecting chute that is connected to the end of the sleeve of the ingredient supplying sleeve and individually collects the ingredient containers.

4. The ingredient supplying device according to claim 1, wherein the ingredient container inverting unit of the ingredient container transporting mechanism comprises an ingredient container carrying-out member that includes a container contact surface curved toward the ingredient containers, horizontally moves the ingredient containers in contact with the container contact surface, and pushes out the ingredient containers from the container carrying-out end, and a pin provided at the container carrying-out end and engaging with an inverting rotation groove provided in a lower portion of the ingredient container to serve as a fulcrum for inverting rotation.

5. The ingredient supplying device according to claim 1, wherein the ingredient supplying sleeve of the ingredient separating mechanism has a drop guide that allows the ingredient container to drop in a vertically inverted state.

6. The ingredient supplying device according to claim 1, wherein the container collecting chute of the ingredient separating mechanism is arranged inclined toward an ingredient container collecting box below the container collecting chute.

7. Ingredient storage equipment comprising:
the ingredient supplying device according to claim 1; and
a heat-retention cabinet in which the ingredient supplying device is incorporated and kept warm, wherein the heat-retention cabinet has a sleeve through-opening that allows the ingredient supplying sleeve of the ingredient separating mechanism to pass through below the ingredient supplying device.
